(19) United States
(12) Patent Application Publication
(10) Pub. No.: US 2008/0074750 A1
(43) Pub. Date: Mar. 27, 2008

(54) Image sensor and fabricating method thereof

(75) Inventor: Joon Hwang, Cheongju-si (KR)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: Dongbu HiTek Co., Ltd.

(21) Appl. No.: 11/897,725

(22) Filed: Aug. 31, 2007

(30) Foreign Application Priority Data
Sep. 26, 2006 (KR) 10-2006-0093577

(51) Int. Cl. G02B 27/12; B29D 11/00

(52) U.S. Cl. 359/628; 264/1.36; 359/619

(57) ABSTRACT

An exemplary image sensor includes a micro lens arranged in a horizontal direction and a vertical direction, neighboring lenses in the horizontal direction and the vertical direction in the micro lens array without having a gap, and a gap between the neighboring lenses in a diagonal direction.

The present application claims priority under 35 U.S.C. 119 and 35 U.S.C. 365 to Korean Patent Application No. 10-2006-0093577 (filed on Sep. 26, 2006), which is hereby incorporated by reference in its entirety.

### BACKGROUND

Embodiments of the invention relate to an image sensor and a fabricating method thereof.

The image sensor is a semiconductor device that converts an optical image into an electrical signal. The image sensor is provided with a micro lens array for collecting and focusing incident light onto a photodiode.

The fabricating method of the image sensor in the related art forms a photoresist pattern array arranged in a horizontal direction and a vertical direction and forms a micro lens array by performing a thermal process such as a reflow process. In the micro lens array, a predetermined gap is formed between neighboring lenses in a horizontal direction and a predetermined gap is formed between lenses neighboring in a vertical direction

However, in fabricating the image sensor, one problem to be solved is to increase a conversion rate, that is, a sensitivity that converts the incident light into the electrical signal.

Meanwhile, in fabricating a highly integrated image sensor, as the pixel pitch is relatively small, the micro lens array with a zero gap is desired in order to effectively guide the incident light to the photodiode. Therefore, in forming the micro lens array for light collection, various manners implementing a zero gap, which does not generate the gap between the neighboring lenses constituting the micro lens array, are devised. However, in forming the micro lens array by means of the photoresist, since the resolution of an exposure apparatus is restricted, there has been the problem that it is difficult to make the gap between the neighboring lenses constituting the micro lens array to be zero.

### SUMMARY

Embodiments of the invention provide an image sensor and a method of fabricating the same by reducing a gap between neighboring lenses in a micro lens array to zero.

An image sensor according to an embodiment includes a micro lens array having a horizontal direction and a vertical direction, wherein neighboring lenses in the horizontal direction and the vertical direction have a zero gap (i.e., no gap) therebetween, but a gap is between neighboring lenses in a diagonal direction of the array.

An image sensor according to another embodiment comprises a lower structure having a plurality of photodiodes and a wiring; and a micro lens array on the lower structure and configured to focus light on a corresponding photodiode, wherein neighboring lenses in a horizontal direction and a vertical direction in the micro lens array have a zero gap therebetween, and a gap or space is between neighboring lenses in a diagonal direction.

A method of fabricating an image sensor according to another embodiment comprises forming a patterned photoresist array having a horizontal direction and a vertical direction; and forming a micro lens array in the horizontal direction and the vertical direction by thermally processing the patterned photoresist array, wherein neighboring lenses in the horizontal direction and the vertical direction are without a gap therebetween (i.e., a zero gap), and neighboring lenses in a diagonal direction have a gap or space therebetween.

### BRIEF DESCRIPTION OF THE DRAWINGS

FIGS. 1 to 5 are views for explaining a fabricating method of an image sensor according to the embodiment.

### DETAILED DESCRIPTION OF THE EMBODIMENTS

In the description of the following embodiments, when each layer (film), an area, a pattern or structures are described to be formed “on/above” or “below/under” each layer (film), the area, the pattern or the structures, it can be understood as the case that each layer (film), an area, a pattern or structures are formed by being directly contacted to each layer (film), the area, the pattern or the structures and it can further be understood as the case that other layer (film), other area, other pattern or other structures are additionally formed therebetween. Therefore, the meanings should be judged according to the technical idea of the embodiment.

Hereinafter, embodiments of the invention will be described with reference to the accompanying drawings.

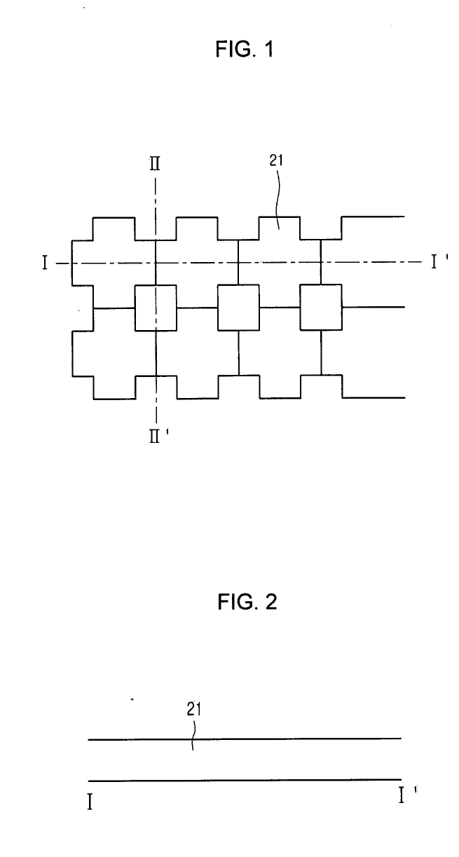

The method of fabricating the image sensor according to the embodiment will be described with reference to FIGS. 1 to 5.

In the present method of fabricating the image sensor according to one embodiment, a photoresist is deposited onto a substrate and then formed into a patterned array 21, arranged in a horizontal direction and a vertical direction as shown in FIG. 1. Patterning generally comprises conventional photolithographic exposure and development. The patterned photoresist array 21 may comprise a first plurality of parallel lines (e.g., along the line labeled I-I′) and second plurality of parallel lines intersecting the first plurality of parallel lines (e.g., along the line labeled II-II′). In one embodiment, the first and second pluralities of parallel lines are orthogonal to each other.

According to one embodiment, the patterned photoresist array 21 comprises neighboring patterned photoresist units in the horizontal direction and the vertical direction without a gap therebetween, but a space is formed between the neighboring patterned photoresist units in a diagonal direction. Patterned units or microlenses in the present array may also be arranged in rows and columns, terms that may be used interchangeably with “horizontal direction” and “vertical direction.” In general, a diagonal direction in the present array may be along a line or axis defined by one patterned unit or microlens and a neighboring patterned unit or microlens that is one row and one column away from the one patterned unit.

As shown in part in FIG. 1, four lenses, constituted by two neighboring patterned units or microlenses in a horizontal direction and two neighboring patterned units or microlenses in the same vertical direction (e.g., above or below the row of the two neighboring patterned units or microlenses in the horizontal direction) in the patterned photoresist array 21, may define a square space. Alternatively, the four lenses may define a rectangular space or other shape (e.g., a diamond shape or a cross or “plus sign” shape [for example, [symbol] the latter case of which the length of the opening between adjacent contact regions [e.g., along line II-II′] may be longer than the square shape embodiment, but the width may be smaller).

FIG. 2 is a cross sectional view taken along axis I-I′ of the patterned photoresist array shown in FIG. 1, and FIG. 4 is a cross sectional view taken along axis II-II′ of the patterned photoresist array shown in FIG. 1. In other words, as shown in FIG. 2, the neighboring patterned photoresist units in the horizontal direction and the vertical direction have a planar upper surface, generally formed by spin coating the photoresist onto a planar surface (such as a dielectric planarization layer on a conventional image sensor). Also, as shown in FIG. 4, the patterned photoresist has a predetermined gap along the neighboring boundary surfaces in the horizontal direction and the vertical direction between the patterned photoresist units. For example, if the pre-patterned photoresist units occupy a square or rectangular space in the image sensor layout, the gaps generally are formed in the corners of the square or rectangular space.

In the exemplary method of fabricating an image sensor, thermal processing is performed on the patterned photoresist array 21. As one example, thermal processing may comprise a reflow process, which may be performed at a temperature of from 120 to 250° C. or any range of values therein (e.g., from 150 to 200° C.), and/or for a length of time sufficient to round or curve the patterned photoresist units. The micro lens array 21a arranged in the horizontal direction and the vertical direction can be formed through the thermal processing on the patterned array 21.

In various exemplary embodiments, as the thermal processing is performed on the patterned photoresist array 21, photoresist material at boundary surfaces between neighboring patterned photoresist units in the horizontal direction and the vertical direction may move to a predetermined space in the diagonal direction of the photoresist pattern. Continuous bends are formed between the neighboring patterned photoresist units in the horizontal direction and the vertical direction (e.g., the neighboring photoresist units are curved or rounded).

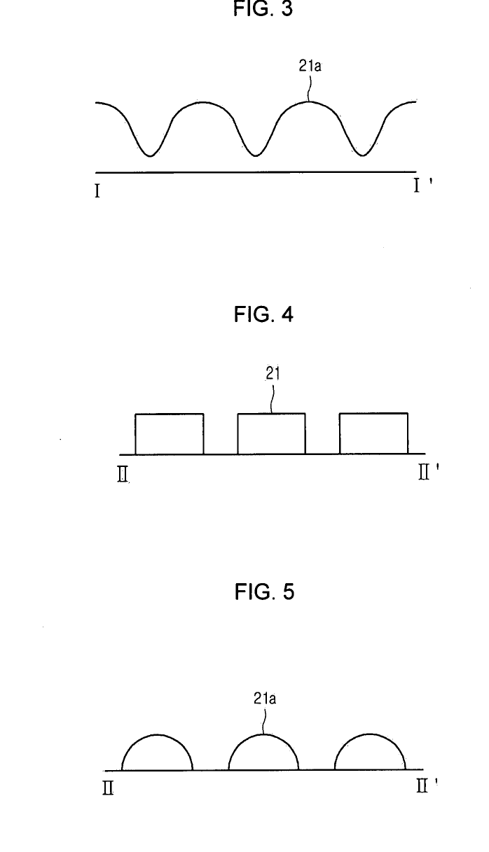

FIG. 3 is a cross sectional view taken along I-I′ of the products of the photo pattern array shown in FIG. 1, after thermal processing, and FIG. 5 is a cross sectional view taken along II-II′ of the products of the photo pattern array shown in FIG. 1, after thermal processing

With the exemplary embodiment shown in FIG. 3, it can be confirmed that the neighboring lenses in the horizontal direction and the vertical direction in the micro lens array 21a are continuously formed without having a gap between them along the horizontal and vertical axes. That is, they have continuous bends (e.g., a curved or rounded shape), and the continuous bends form or have a smooth boundary line.

Such a micro lens array 21a can have a zero gap shape (e.g., without having a gap between the neighboring lenses in the horizontal direction and the vertical direction). Thereby, in an image sensor having a highly integrated pixel pitch, the efficiency of light collected on the photodiode positioned in the lower structure under a particular microlens can further be improved.

Also, as shown in FIG. 5, the micro lens array 21a has a predetermined gap along the neighboring boundary surfaces in the diagonal direction. At this time, the respective patterned photoresist units can be formed in the lens shape (e.g., having a continuous bends or a rounded or continuously curved shape) by the thermal processing process. As such, a predetermined gap is formed between the neighboring lenses in a diagonal direction in the micro lens array 21a. In the exemplary micro lens array 21a, a gap of 0.2 to 0.7 μm is formed between the neighboring lenses in the diagonal direction. Also, with the embodiment(s) shown in the Figures, the contact surfaces of four neighboring lenses, which include two neighboring lenses in a horizontal direction and two neighboring lenses thereto in the same vertical direction in the micro lens array 21a, are formed with an approximate quadrilateral (e.g., square) space. At this time, a length of one side forming the approximate square space formed between the contact regions of the four lenses can have a length of 0.2 to 0.5 μm. In another embodiment, the length of a cross or “plus sign” shaped space can have a length of from 0.35 to 0.7 μm and a width of from 0.1 to 0.25 μm.

As described above, with the method of fabricating an image sensor, the micro lens array 21a having a zero gap can be formed on the lower structure having a corresponding photodiode array and the wiring. The image sensor according to various embodiments comprises a micro lens array 21a having neighboring lenses in the horizontal direction and the vertical direction that are continuously formed and neighboring lenses in a diagonal direction with a predetermined gap therebetween. With certain embodiments, the gap may have one or more dimensions of from 0.2 to about 0.7 μm between the neighboring lenses in a diagonal direction.

Also, with some embodiments, four neighboring lenses, which can be defined by two neighboring lenses in a horizontal direction and two neighboring lenses thereto (i.e., adjacent to the two horizontal neighboring lenses) in the same vertical direction (e.g., above or below the row along axis I-I′ in the Figures) form an approximately square space between the contact regions thereof. At this time, a length of one side forming the approximate square space formed at the contacts of the four lenses constituting the micro lens array 21a can be from 0.2 to 0.5 μm.

In the above described image sensor, the neighboring lenses in the horizontal direction and the vertical direction in the micro lens array 21a can have a zero gap therebetween. Therefore, in image sensors having a highly integrated pixel pitch, the efficiency of light collected on the photodiode can further be improved. As described above, with the image sensor and the fabricating method thereof, the gap between the neighboring lenses constituting the micro lens array is formed along the diagonal direction, but with a zero gap in the horizontal and vertical directions, making it possible to improve the sensitivity of the device.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An image sensor, comprising an array of micro lenses and a plurality of gaps, wherein the array of micro lenses has a horizontal direction a vertical direction, neighboring lenses in the horizontal direction and the vertical direction have a zero gap therebetween, and the gaps are between neighboring lenses in a diagonal direction.

2. The image sensor according to claim 1, wherein the gaps have a size of 0.2 to 0.7 μm.

3. The image sensor according to claim 1, wherein two neighboring lenses in the horizontal direction and two neighboring lenses thereto in a same vertical direction define a quadrilateral space.

4. The image sensor according to claim 3, wherein the quadrilateral space is a square space.

5. The image sensor according to claim 4, wherein a length of the square space is from 0.2 to 0.5 μm.

6. An image sensor, comprising:
a lower structure having a plurality of photodiodes and a wiring; and
a micro lens array on the lower structure having a horizontal direction a vertical direction, each micro lens being configured to focus light on a corresponding photodiode,
wherein neighboring lenses in the horizontal direction and the vertical direction have a zero gap therebetween, and a gap or space is between neighboring lenses in a diagonal direction.

7. The image sensor according to claim 6, wherein the gap or space has a size of 0.2 to 0.7 μm.

8. The image sensor according to claim 6, wherein two neighboring lenses in the horizontal direction and two neighboring lenses thereto in a same vertical direction define a quadrilateral space.

9. The image sensor according to claim 8, wherein the quadrilateral space is a square space.

10. The image sensor according to claim 9, wherein a length of the square space is from 0.2 to 0.5 μm.

11. The image sensor according to claim 6, wherein the gap or space has a cross or plus sign shape.

12. A method of fabricating an image sensor comprising:
forming a patterned photoresist array having in a horizontal direction and a vertical direction; and
forming a micro lens array in the horizontal direction and the vertical direction by thermally processing the patterned photoresist array, wherein neighboring lenses in the horizontal direction and the vertical direction have a zero gap therebetween, and neighboring lenses in a diagonal direction have a gap or space therebetween.

13. The method according to claim 12, wherein thermally processing the patterned photoresist array comprises a reflow process.

14. The method according to claim 13, wherein the reflow process is performed at a temperature of from 120 to 250° C.

15. The method according to claim 14, wherein the reflow process is performed at a temperature is from 150 to 200° C.

16. The method according to claim 13, wherein the reflow process is performed for a length of time sufficient to round or curve the patterned photoresist units.

17. The method according to claim 12, wherein the gap or space has a size of 0.2 to 0.7 μm.

18. The method according to claim 12, wherein two neighboring lenses in a horizontal direction and two neighboring lenses thereto in a vertical direction define a square space.

19. The method according to claim 18, wherein a length of the square space is from 0.2 to 0.5 μm.

20. The method claim 12, wherein thermally processing the patterned photoresist array reflows photoresist to a predetermined space between neighboring patterned units in the diagonal direction.
